(19) United States
(12) Patent Application Publication
(10) Pub. No.: US 2026/0290674 A1
(43) Pub. Date: Sep. 24, 2026

(54) INDUCTOR COMPONENT

(71) Applicant: Murata Manufacturing Co., Ltd., Kyoto-fu (JP)

(72) Inventors: Kenji TOYOSHIMA, Nagaokakyo-shi (JP); Yoshimasa YOSHIOKA, Nagaokakyo-shi (JP); Taiga KATO, Nagaokakyo-shi (JP)

(73) Assignee: Murata Manufacturing Co., Ltd., Kyoto-fu (JP)

(21) Appl. No.: 19/557,695

(22) Filed: Mar. 5, 2026

(30) Foreign Application Priority Data
Mar. 18, 2025 (JP) 2025-043425

(51) Int. Cl. H01F 27/28; H01F 27/29; H01F 27/32

(52) U.S. Cl. CPC H01F 27/2804; H01F 27/29; H01F 27/323; H01F 2027/2809

(57) ABSTRACT

When currents flow in opposite directions through a first inductor wiring and a second inductor wiring, routing of wirings to an inductor component may be complicated. A first inductor wiring has a first straight wiring extending linearly. A second inductor wiring has a linear second straight wiring extending parallel to the first straight wiring. When viewed in a direction orthogonal to a first main surface, the second inductor wiring intersects the first inductor wiring at an intersection portion. A first pad of the first inductor wiring is located on a side opposite to a second pad of the first inductor wiring across the second straight wiring. A first pad of the second inductor wiring is located on a side opposite to a second pad of the second inductor wiring across the first straight wiring.

### CROSS-REFERENCE TO RELATED APPLICATION

This application claims benefit of priority to Japanese Patent Application No. 2025-043425, filed Mar. 18, 2025, the entire content of which is incorporated herein by reference.

### BACKGROUND

### Technical Field

The present disclosure relates to an inductor component.

### Background Art

The inductor component disclosed in Japanese Patent Application Laid-Open No. 2021-077714 includes an element body, a first straight wiring, and a second straight wiring. The first straight wiring and the second straight wiring extend parallel to a main surface of the element body inside the element body. The first straight wiring and the second straight wiring extend parallel to each other. The inductor component includes four vertical wirings and four external terminals. Each of the vertical wirings extends, inside the element body, from an end portion of each of the straight wirings in a direction orthogonal to the main surface of the element body. Each of external terminals covers a part of the main surface of the element body. Each of external terminals is connected to the end portion of the first straight wiring or the end portion of the second straight wiring via a corresponding vertical wiring.

### SUMMARY

In the inductor component as disclosed in Japanese Patent Application Laid-Open No. 2021-077714, it is assumed that a voltage is applied to the first straight wiring and the second straight wiring so that currents flow in opposite directions to each other. In this case, an end of the first straight wiring to which a high potential is applied and an end of the second straight wiring to which a low potential is applied are present on one side of the inductor component. Therefore, it is necessary to route a wiring for supplying the high potential to the first straight wiring and a wiring for supplying the low potential to the second straight wiring to the one side of the inductor component. In other words, an input terminal having a high potential and an output terminal having a low potential are connected to the same side of the inductor component. Therefore, when the inductor component as described above is mounted on a substrate or the like, a wiring routing structure may be complicated.

Accordingly, the present disclosure provides an inductor component including an element body having a planar main surface; a first inductor wiring extending parallel to the main surface in the element body; a second inductor wiring located in a layer different from the first inductor wiring in a direction orthogonal to the main surface and extending parallel to the main surface in the element body; and a plurality of vertical wirings electrically connected to a wiring inside the element body, and extending in a direction intersecting the main surface to be exposed on an outer surface of the element body. The first inductor wiring includes a first straight wiring extending linearly, the second inductor wiring includes a linear second straight wiring extending parallel to the first straight wiring, and the second inductor wiring intersects the first inductor wiring when viewed in a direction orthogonal to the main surface. A first end of the first inductor wiring is located on a side opposite to a second end of the first inductor wiring across the second straight wiring, and a first end of the second inductor wiring is located on a side opposite to a second end of the second inductor wiring across the first straight wiring.

When currents flow in opposite directions through the first inductor wiring and the second inductor wiring, an end of the first inductor wiring to which a high potential is applied and an end of the second inductor wiring to which a high potential is applied are arranged on one side of the inductor component.

### BRIEF DESCRIPTION OF THE DRAWINGS

FIG. 1 is a top view of an inductor component;

FIG. 2 is a sectional view taken along line 2-2 in FIG. 1;

FIG. 3 is a sectional view taken along line 3-3 in FIG. 2;

FIG. 4 is a sectional view taken along line 4-4 in FIG. 2;

FIG. 5 is a sectional view taken along line 5-5 in FIG. 2;

FIG. 6 is a sectional view taken along line 6-6 in FIG. 2;

FIG. 7 is a sectional view taken along line 7-7 in FIG. 2;

FIG. 8 is a sectional view taken along line 8-8 in FIG. 2;

FIG. 9 is an explanatory view of a method for manufacturing the inductor component;

FIG. 10 is an explanatory view of the method for manufacturing the inductor component;

FIG. 11 is an explanatory view of the method for manufacturing the inductor component;

FIG. 12 is an explanatory view of the method for manufacturing the inductor component;

FIG. 13 is an explanatory view of the method for manufacturing the inductor component;

FIG. 14 is an explanatory view of the method for manufacturing the inductor component;

FIG. 15 is an explanatory view of the method for manufacturing the inductor component;

FIG. 16 is an explanatory view of the method for manufacturing the inductor component;

FIG. 17 is an explanatory view of the method for manufacturing the inductor component;

FIG. 18 is a top view of the inductor component according to a modification;

FIG. 19 is a top view of the inductor component according to the modification;

FIG. 20 is a top view of the inductor component according to the modification; and

FIG. 21 is a sectional view of the inductor component according to the modification.

### DETAILED DESCRIPTION

### Embodiment of Inductor Component

Hereinafter, an embodiment of an inductor component will be described. Note that constituent elements may be illustrated in an enlarged manner in the drawings for the sake of easy understanding. Dimensional ratios of the constituent elements may be different from actual ones or those in another drawing. In addition, in the following description, terms indicating a relationship between elements, for example, terms such as parallel, perpendicular, and orthogonal, and terms such as a straight line indicating a shape of an element do not mean only strict aspects. For example, each term includes a substantially equivalent range, for example, a difference of about several % in consideration of a manufacturing error and the like.

### Schematic Configuration of Inductor Component

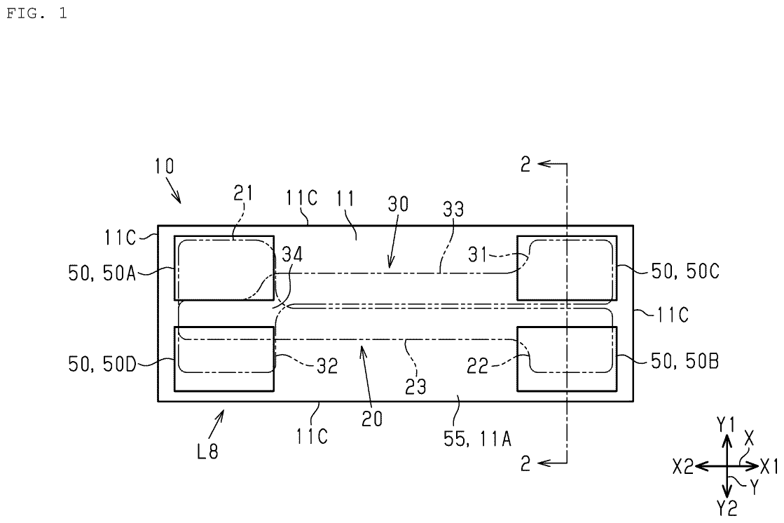

As illustrated in FIG. 1, an inductor component 10 includes an element body 11. The element body 11 has a substantially rectangular parallelepiped shape. That is, the element body 11 has six planar outer surfaces. Note that a plane herein may be any plane as long as it can be visually recognized as a plane when the element body 11 is viewed from above. Therefore, even when there is a minute unevenness or the like that cannot be observed unless a part is enlarged with a microscope or the like, it is referred to as a plane.

Hereinafter, as illustrated in FIG. 1, one specific surface among the six outer surfaces of the element body 11 is referred to as a first main surface 11A. Note that in FIG. 1, the first main surface 11A to be described later is denoted by the same reference numeral as an outer surface of a protective film 55 to be described later. As illustrated in FIG. 2, a surface facing an opposite side to the first main surface 11A and parallel to the first main surface 11A is referred to as a second main surface 11B. Furthermore, four surfaces perpendicular to the first main surface 11A are referred to as side surfaces 11C of the element body 11. An outer shape of the first main surface 11A is a rectangular shape having a short side and a long side longer than the short side. An outer shape of the second main surface 11B is substantially congruent with the outer shape of the first main surface 11A.

Here, as illustrated in FIG. 1, an axis parallel to the long side of the first main surface 11A is referred to as a first axis X. An axis parallel to the short side of the first main surface 11A is referred to as a second axis Y. As illustrated in FIG. 2, an axis orthogonal to the first main surface 11A is referred to as a third axis Z. In the present embodiment, the first axis X, the second axis Y, and the third axis Z are orthogonal to each other. Further, as illustrated in FIG. 1, a specific direction among directions along the first axis X is referred to as a first positive direction X1, and a direction opposite to the first positive direction X1 is referred to as a first negative direction X2. Further, a specific direction among directions along the second axis Y is referred to as a second positive direction Y1, and a direction opposite to the second positive direction Y1 is referred to as a second negative direction Y2. Furthermore, as illustrated in FIG. 2, among directions along the third axis Z, a direction in which the first main surface 11A faces is referred to as a third positive direction Z1, and a direction opposite to the third positive direction Z1 is referred to as a third negative direction Z2.

As illustrated in FIG. 2, the inductor component 10 includes a first inductor wiring 20, a first via wiring 25, and a first auxiliary wiring 26. The first inductor wiring 20 extends parallel to the first main surface 11A inside the element body 11. The first via wiring 25 extends parallel to the first main surface 11A inside the element body 11. The first via wiring 25 is located on the third positive direction Z1 side with respect to the first inductor wiring 20. A surface of the first via wiring 25 on the third negative direction Z2 side is connected to a surface of the first inductor wiring 20 on the third positive direction Z1 side. The first auxiliary wiring 26 extends parallel to the first main surface 11A inside the element body 11. The first auxiliary wiring 26 is located on the third positive direction Z1 side with respect to the first via wiring 25. A surface of the first auxiliary wiring 26 on the third negative direction Z2 side is connected to a surface of the first via wiring 25 on the third positive direction Z1 side. Therefore, the first via wiring 25 is located between the first inductor wiring 20 and the first auxiliary wiring 26 in a direction parallel to the third axis Z. Then, the first via wiring 25 connects the first inductor wiring 20 and the first auxiliary wiring 26.

The inductor component 10 includes a second inductor wiring 30, a second via wiring 35, and a second auxiliary wiring 36. The second inductor wiring 30 extends parallel to the first main surface 11A inside the element body 11. The second inductor wiring 30 is located in a layer different from the first inductor wiring 20 in the direction parallel to the third axis Z. Specifically, the second inductor wiring 30 is located in the same layer as the first auxiliary wiring 26.

The second via wiring 35 extends parallel to the first main surface 11A inside the element body 11. The second via wiring 35 is located on the third negative direction Z2 side with respect to the second inductor wiring 30. A surface of the second via wiring 35 on the third positive direction Z1 side is connected to a surface of the second inductor wiring 30 on the third negative direction Z2 side. The second auxiliary wiring 36 extends parallel to the first main surface 11A inside the element body 11. The second auxiliary wiring 36 is located on the third negative direction Z2 side with respect to the second via wiring 35. Specifically, the second auxiliary wiring 36 is located in the same layer as the first inductor wiring 20. A surface of the second auxiliary wiring 36 on the third positive direction Z1 side is connected to a surface of the second via wiring 35 on the third negative direction Z2 side. Therefore, the second via wiring 35 is located between the second inductor wiring 30 and the second auxiliary wiring 36 in the direction parallel to the third axis Z. Then, the second via wiring 35 connects the second inductor wiring 30 and the second auxiliary wiring 36.

The inductor component 10 includes four vertical wirings 40 connected to wirings inside the element body 11. Note that in FIG. 2, only two vertical wirings 40 are illustrated. Each of the vertical wirings 40 extends parallel to the third axis Z inside the element body 11. Each of the vertical wirings 40 is located on the third positive direction Z1 side from a layer in which the first auxiliary wiring 26 and the second inductor wiring 30 are present. Two of the vertical wirings 40 are electrically connected to the first inductor wiring 20. Remaining two of the vertical wirings 40 are electrically connected to the second inductor wiring 30. An end surface of each of the vertical wirings 40 on the third positive direction Z1 side is exposed on the first main surface 11A of the element body 11.

The inductor component 10 includes four external terminals 50. Note that in FIG. 2, only two external terminals 50 are illustrated. Each of external terminals 50 covers a part of the first main surface 11A of the element body 11. Each of the external terminals 50 covers an end surface of the corresponding vertical wiring 40 on the third positive direction Z1 side. Therefore, each of external terminals 50 is connected to the corresponding vertical wiring 40.

### Detailed Configuration of Inductor Component

As illustrated in FIG. 2, the inductor component 10 is roughly divided into a first layer L1, a second layer L2, a third layer L3, a fourth layer L4, a fifth layer L5, a sixth layer L6, a seventh layer L7, and an eighth layer L8 in order from an end on the third negative direction Z2 side toward the third positive direction Z1. Note that depending on a position of the inductor component 10, a clear boundary line may not be observed between adjacent layers among the first layer L1 to the eighth layer L8. In this case, “a plurality of elements are located in different layers” means that the elements are located in different regions in a layer stacking direction.

As illustrated in FIG. 2, the first layer L1 has a rectangular plate shape. A surface of the first layer L1 facing the third negative direction Z2 side is the second main surface 11B. The first layer L1 includes only the element body 11. A material of the element body 11 includes a magnetic material. Specifically, the material of the element body 11 is an organic resin containing metal magnetic powder. In the present embodiment, the metal magnetic powder is a metal magnetic powder made of an Fe-based alloy or an amorphous alloy. Examples of the metal magnetic powder include FeSiCr-based metal powder.

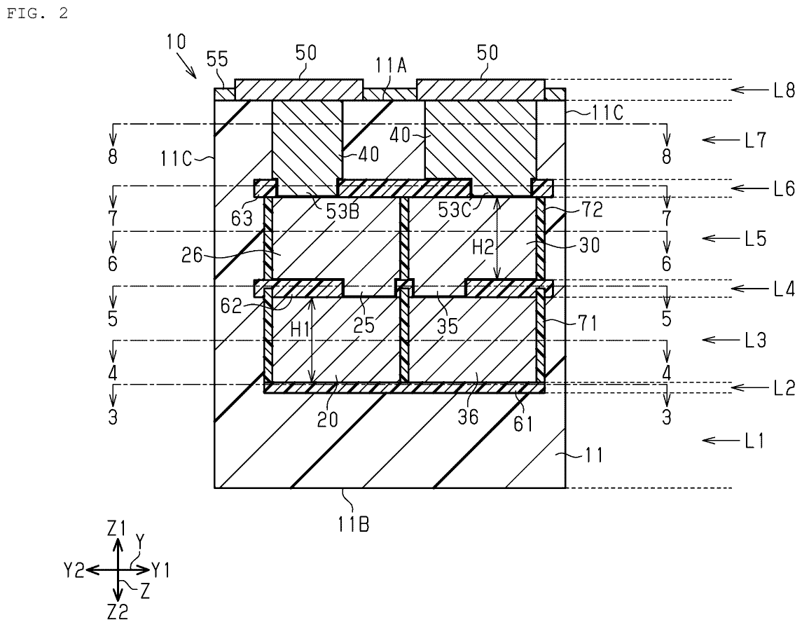

As illustrated in FIG. 2, the second layer L2 is laminated on the third positive direction Z1 side with respect to the first layer L1. As illustrated in FIG. 3, an outer shape of the second layer L2 is the same rectangular shape as the first layer L1. The second layer L2 includes a first interlayer insulating layer 61 and the element body 11. A portion of the second layer L2 excluding the first interlayer insulating layer 61 is the element body 11. Note that in sectional views of FIGS. 3 to 8, hatching is omitted.

A material of the first interlayer insulating layer 61 is an insulating resin. The first interlayer insulating layer 61 is elongated in a direction parallel to the first axis X as a whole, and extends over substantially an entire second layer L2. However, the first interlayer insulating layer 61 does not reach an outer edge of the second layer L2. A dimension of the first interlayer insulating layer 61 in a direction parallel to the second axis Y increases at both end portions of the first interlayer insulating layer 61. Then, in a central portion of the first interlayer insulating layer 61, a dimension in the direction parallel to the second axis Y is constant.

As illustrated in FIG. 2, the third layer L3 is laminated on the third positive direction Z1 side with respect to the second layer L2. As illustrated in FIG. 4, an outer shape of the third layer L3 is the same rectangular shape as the first layer L1. The third layer L3 includes the first inductor wiring 20, the second auxiliary wiring 36, a first in-layer insulating layer 71, and the element body 11. A portion of the third layer L3 excluding the first inductor wiring 20, the second auxiliary wiring 36, and the first in-layer insulating layer 71 is the element body 11. A material of the first inductor wiring 20 and a material of the second auxiliary wiring 36 are both conductive metals, for example, copper.

As illustrated in FIG. 2, the first inductor wiring 20 extends on the first interlayer insulating layer 61 in the second layer L2. Note that although not illustrated in FIG. 2, a seed layer for forming the first inductor wiring 20 is present near a boundary with the first interlayer insulating layer 61 in the first inductor wiring 20.

As illustrated in FIG. 4, the first inductor wiring 20 includes a first pad 21, a second pad 22, and a first straight wiring 23. The first pad 21 has a quadrangular shape in plan view. The first pad 21 is located at a corner on the first negative direction X2 side and the second positive direction Y1 side in the third layer L3. The first pad 21 constitutes a first end of the first inductor wiring 20. The second pad 22 has a quadrangular shape in plan view. The second pad 22 is located at a corner on the first positive direction X1 side and the second negative direction Y2 side in the third layer L3. The second pad 22 constitutes a second end of the first inductor wiring 20. The first straight wiring 23 extends linearly. Specifically, the first straight wiring 23 extends parallel to the first axis X. Therefore, the first straight wiring 23 extends parallel to the long side of the first main surface 11A. An end of the first straight wiring 23 on the first negative direction X2 side is connected to the first pad 21. An end of the first straight wiring 23 on the first positive direction X1 side is connected to the second pad 22. Note that when viewed in the direction parallel to the third axis Z, an entire first inductor wiring 20 falls within a range of the first interlayer insulating layer 61 described above.

A proportion of the first straight wiring 23 in the first inductor wiring 20 is 50% or more of a length of the first inductor wiring 20. Note that the length of the first inductor wiring 20 refers to a length of a center line of the first inductor wiring 20. The center line of the first inductor wiring 20 is a set of midpoints of line segments connecting one point on one side edge of the first inductor wiring 20 to the other side edge at the shortest distance.

A shortest distance from the first straight wiring 23 to the side surface 11C of the element body 11 in a direction parallel to the first main surface 11A and orthogonal to an extending direction of the first straight wiring 23 is referred to as a shortest distance D1. At this time, the shortest distance D1 is larger than a maximum width dimension D2 of the first straight wiring 23 in the direction parallel to the first main surface 11A. Note that the maximum width dimension D2 of the first straight wiring 23 is a maximum value among dimensions in a direction orthogonal to a center line of the first straight wiring 23 when viewed in a direction orthogonal to the first main surface 11A.

As illustrated in FIG. 2, the second auxiliary wiring 36 extends on the first interlayer insulating layer 61 in the second layer L2. Note that although not illustrated in FIG. 2, a seed layer for forming the second auxiliary wiring 36 is present near a boundary with the first interlayer insulating layer 61 in the second auxiliary wiring 36.

As illustrated in FIG. 4, the second auxiliary wiring 36 includes a pad 37 and a second wiring portion 38. The pad 37 has a quadrangular shape in plan view. The pad 37 is located at a corner on the first positive direction X1 side and the second positive direction Y1 side in the third layer L3. The second wiring portion 38 extends linearly. Specifically, the second wiring portion 38 extends parallel to the first axis X on the second positive direction Y1 side with respect to the first straight wiring 23. An end of the second wiring portion 38 on the first positive direction X1 side is connected to the pad 37. An end of the second wiring portion 38 on the first negative direction X2 side does not reach the first pad 21 of the first inductor wiring 20. That is, the second auxiliary wiring 36 is not connected to the first inductor wiring 20. Note that when viewed in the direction parallel to the third axis Z, an entire second auxiliary wiring 36 falls within the range of the first interlayer insulating layer 61 described above.

As illustrated in FIG. 2, the first in-layer insulating layer 71 covers a side surface of the first inductor wiring 20. The side surface here is a surface facing a direction orthogonal to the third axis Z. In FIG. 4, the first in-layer insulating layer 71 is illustrated by a thick line. As illustrated in FIG. 4, the first in-layer insulating layer 71 extends over an entire outer edge of the first inductor wiring 20. As illustrated in FIG. 2, the first in-layer insulating layer 71 covers a side surface of the second auxiliary wiring 36. As illustrated in FIG. 4, the first in-layer insulating layer 71 extends over an entire outer edge of the second auxiliary wiring 36.

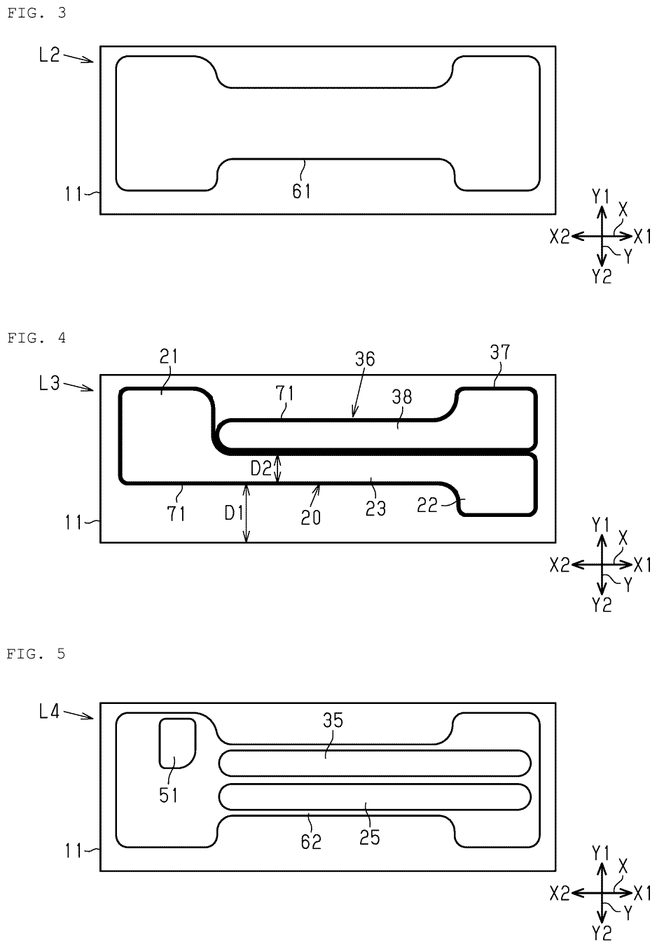

As illustrated in FIG. 2, the fourth layer L4 is laminated on the third positive direction Z1 side with respect to the third layer L3. As illustrated in FIG. 5, an outer shape of the fourth layer L4 is the same rectangular shape as the first layer L1. The fourth layer L4 includes a second interlayer insulating layer 62, the first via wiring 25, the second via wiring 35, a via portion 51, and the element body 11. A portion of the fourth layer L4 excluding the second interlayer insulating layer 62, the first via wiring 25, the second via wiring 35, and the via portion 51 is the element body 11. A material of the second interlayer insulating layer 62 is an insulating resin. Therefore, the second interlayer insulating layer 62 is made of a material having a larger electric resistance value than the element body 11. A material of the first via wiring 25, a material of the second via wiring 35, and a material of the via portion 51 are all conductive metals, for example, copper.

An outer shape of the second interlayer insulating layer 62 is the same shape as the first interlayer insulating layer 61. When viewed in the direction parallel to the third axis Z, an outer edge of the second interlayer insulating layer 62 substantially coincides with an outer edge of the first interlayer insulating layer 61. The second interlayer insulating layer 62 is located between the first inductor wiring 20 and the second inductor wiring 30 in the direction parallel to the third axis Z.

As illustrated in FIG. 2, the first via wiring 25 extends on the first inductor wiring 20 in the third layer L3. Note that although not illustrated in FIG. 2, a seed layer for forming the first via wiring 25 is present near a boundary with the first inductor wiring 20 in the first via wiring 25.

As illustrated in FIG. 5, the first via wiring 25 extends linearly. Specifically, the first via wiring 25 extends parallel to the first axis X. When viewed in the direction parallel to the third axis Z, a position of the first via wiring 25 overlaps the first straight wiring 23 of the first inductor wiring 20. Furthermore, when viewed in the direction parallel to the third axis Z, an end of the first via wiring 25 on the first positive direction X1 side reaches a position overlapping the second pad 22. Note that a maximum dimension of the first via wiring 25 in the direction parallel to the first main surface 11A is smaller than the maximum width dimension D2 of the first straight wiring 23 described above.

As illustrated in FIG. 2, the second via wiring 35 extends on the second auxiliary wiring 36 in the third layer L3. Note that although not illustrated in FIG. 2, a seed layer for forming the second via wiring 35 is present near a boundary with the second auxiliary wiring 36 in the second via wiring 35.

As illustrated in FIG. 5, the second via wiring 35 extends linearly. Specifically, the second via wiring 35 extends parallel to the first axis X on the second positive direction Y1 side with respect to the first via wiring 25. When viewed in the direction parallel to the third axis Z, a position of the second via wiring 35 overlaps the second wiring portion 38 of the second auxiliary wiring 36. Furthermore, when viewed in the direction parallel to the third axis Z, an end of the second via wiring 35 on the first positive direction X1 side reaches a position overlapping the pad 37. Note that a maximum dimension of the second via wiring 35 in the direction parallel to the first main surface 11A is smaller than a maximum width dimension of the second wiring portion 38.

The via portion 51 is located on the first inductor wiring 20 in the third layer L3. Note that although not illustrated, a seed layer for forming the via portion 51 is present near a boundary with the first inductor wiring 20 in the via portion 51.

The via portion 51 has a substantially quadrangular shape in plan view. The via portion 51 is located at a corner on the first negative direction X2 side and the second positive direction Y1 side in the fourth layer L4. When viewed in the direction parallel to the third axis Z, an entire via portion 51 overlaps the first pad 21 of the first inductor wiring 20.

As illustrated in FIG. 2, the fifth layer L5 is laminated on the third positive direction Z1 side with respect to the fourth layer L4. As illustrated in FIG. 6, an outer shape of the fifth layer L5 is the same rectangular shape as the first layer L1. The fifth layer L5 includes the second inductor wiring 30, the first auxiliary wiring 26, a second in-layer insulating layer 72, an intermediate pad 52, and the element body 11. A portion of the fifth layer L5 excluding the second inductor wiring 30, the first auxiliary wiring 26, the second in-layer insulating layer 72, and the intermediate pad 52 is the element body 11. A material of the second in-layer insulating layer 72 is an insulating resin. A material of the second inductor wiring 30, a material of the first auxiliary wiring 26, and a material of the intermediate pad 52 are all conductive metals, for example, copper.

As illustrated in FIG. 2, the second inductor wiring 30 extends on the second interlayer insulating layer 62 and the second via wiring 35 in the fourth layer L4. Note that although not illustrated in FIG. 2, a seed layer for forming the second inductor wiring 30 is present near a boundary with the second interlayer insulating layer 62 in the second inductor wiring 30.

As illustrated in FIG. 6, the second inductor wiring 30 includes a first pad 31, a second pad 32, a second straight wiring 33, and an intersection portion 34. The first pad 31 has a quadrangular shape in plan view. The first pad 31 is located at a corner on the first positive direction X1 side and the second positive direction Y1 side in the fifth layer L5. The first pad 31 constitutes a first end of the second inductor wiring 30. The second pad 32 has a quadrangular shape in plan view. The second pad 32 is located at a corner on the first negative direction X2 side and the second negative direction Y2 side in the fifth layer L5. The second pad 32 constitutes a second end of the second inductor wiring 30. The second straight wiring 33 extends linearly. Specifically, the second straight wiring 33 extends parallel to the first axis X. Therefore, the second straight wiring 33 extends parallel to the long side of the first main surface 11A. When viewed in the direction parallel to the third axis Z, the second straight wiring 33 overlaps the second via wiring 35 in the fourth layer L4 and the second auxiliary wiring 36 in the third layer L3. An end of the second straight wiring 33 on the first positive direction X1 side is connected to the first pad 31. The intersection portion 34 connects an end of the second straight wiring 33 on the first negative direction X2 side and the second pad 32. The intersection portion 34 obliquely extends toward the second positive direction Y1 side from the second pad 32 toward the first positive direction X1 side. As a result, an entire second straight wiring 33 is located on the second positive direction Y1 side from the second pad 32. Note that when viewed in the direction parallel to the third axis Z, an entire second inductor wiring 30 falls within a range surrounded by the outer edge of the second interlayer insulating layer 62 described above. A proportion of the second straight wiring 33 in the second inductor wiring 30 is 50% or more of a length of the second inductor wiring 30.

Although not illustrated, a shortest distance from the second straight wiring 33 to the side surface 11C of the element body 11 in the direction parallel to the first main surface 11A and orthogonal to the extending direction of the first straight wiring 23 is larger than a maximum width dimension of the second straight wiring 33 in the direction parallel to the first main surface 11A. Note that a definition of the maximum width dimension is the same as that of the first straight wiring 23. Note that the maximum width dimension of the second straight wiring 33 in the direction parallel to the first main surface 11A is larger than a maximum width dimension of the second via wiring 35.

As illustrated in FIG. 2, when viewed in an axis along which the second straight wiring 33 extends, that is, in a section orthogonal to the first axis X, a maximum dimension H2 of the second straight wiring 33 in the direction parallel to the third axis Z orthogonal to the first main surface 11A is within a range of 80% or more and 120% or less (i.e., from 80% to 120%) of a maximum dimension H1 of the first straight wiring 23 in the same direction. Specifically, the maximum dimension H2 of the second straight wiring 33 in the direction parallel to the third axis Z is substantially the same as the maximum dimension H1 of the first straight wiring 23 in the same direction.

As illustrated in FIG. 1, when viewed in the direction parallel to the third axis Z, the second inductor wiring 30 intersects the first inductor wiring 20 at the intersection portion 34. Here, intersecting means that a center line of the second inductor wiring 30 intersects the center line of the first inductor wiring 20.

As described above, the second inductor wiring 30 and the first inductor wiring 20 intersect with each other. As a result, the first pad 21 of the first inductor wiring 20 is located on an opposite side to the second pad 22 of the first inductor wiring 20 across the second straight wiring 33 of the second inductor wiring 30. The first pad 31 of the second inductor wiring 30 is located on an opposite side to the second pad 32 of the second inductor wiring 30 across the first straight wiring 23 of the first inductor wiring 20. More specifically, the first pad 21 of the first inductor wiring 20 and the first pad 31 of the second inductor wiring 30 are both close to the second positive direction Y1 side in the inductor component 10. Then, the second pad 22 of the first inductor wiring 20 and the second pad 32 of the second inductor wiring 30 are both close to the second negative direction Y2 side in the inductor component 10. Note that the fact that the first pad 21 of the first inductor wiring 20 is located on the opposite side to the second pad 22 of the first inductor wiring 20 across the second straight wiring 33 of the second inductor wiring 30 means that a center of gravity of the first pad 21 is located on an opposite side to a center of gravity of the second pad 22 across a center line of the second straight wiring 33. The same applies to a relationship between the first pad 31 and the second pad 32 of the second inductor wiring 30 and the first straight wiring 23 of the first inductor wiring 20.

As illustrated in FIG. 2, the first auxiliary wiring 26 extends on the second interlayer insulating layer 62 and the first via wiring 25 in the fourth layer L4. Note that although not illustrated in FIG. 2, a seed layer for forming the first auxiliary wiring 26 is present near a boundary with the second interlayer insulating layer 62 in the first auxiliary wiring 26.

As illustrated in FIG. 6, the first auxiliary wiring 26 includes a pad 27 and a first wiring portion 28. The pad 27 has a quadrangular shape in plan view. The pad 27 is located at a corner on the first positive direction X1 side and the second negative direction Y2 side in the fifth layer L5. The first wiring portion 28 extends linearly. Specifically, the first wiring portion 28 extends parallel to the first axis X on the second negative direction Y2 side with respect to the second straight wiring 33. When viewed in the direction parallel to the third axis Z, the first auxiliary wiring 26 overlaps the first via wiring 25 in the fourth layer L4 and the first straight wiring 23 of the first inductor wiring 20 in the third layer L3. An end of the first wiring portion 28 on the first positive direction X1 side is connected to the pad 27. An end of the first wiring portion 28 on the first negative direction X2 side does not reach the second pad 32 of the second inductor wiring 30. That is, the first auxiliary wiring 26 is not connected to the second inductor wiring 30. Note that when viewed in the direction parallel to the third axis Z, an entire first auxiliary wiring 26 falls within a range of the second interlayer insulating layer 62 described above. Note that a maximum width dimension of the first wiring portion 28 in the direction parallel to the first main surface 11A is larger than a maximum width dimension of the first via wiring 25.

The intermediate pad 52 has a quadrangular shape in plan view. The intermediate pad 52 is located at a corner on the first negative direction X2 side and the second positive direction Y1 side in the fifth layer L5. Specifically, the intermediate pad 52 is located on the via portion 51 in the fourth layer L4. Note that although not illustrated, a seed layer for forming the intermediate pad 52 is present near a boundary with the via portion 51 in the intermediate pad 52.

As illustrated in FIG. 2, the second in-layer insulating layer 72 covers a side surface of the second inductor wiring 30. Note that in FIG. 6, the second in-layer insulating layer 72 is illustrated by a thick line. As illustrated in FIG. 6, the second in-layer insulating layer 72 extends over an entire outer edge of the second inductor wiring 30. As illustrated in FIG. 2, the second in-layer insulating layer 72 covers a side surface of the first auxiliary wiring 26. As illustrated in FIG. 6, the second in-layer insulating layer 72 extends over an entire outer edge of the first auxiliary wiring 26. The second in-layer insulating layer 72 covers a side surface of the intermediate pad 52. The second in-layer insulating layer 72 extends over an entire outer edge of the intermediate pad 52.

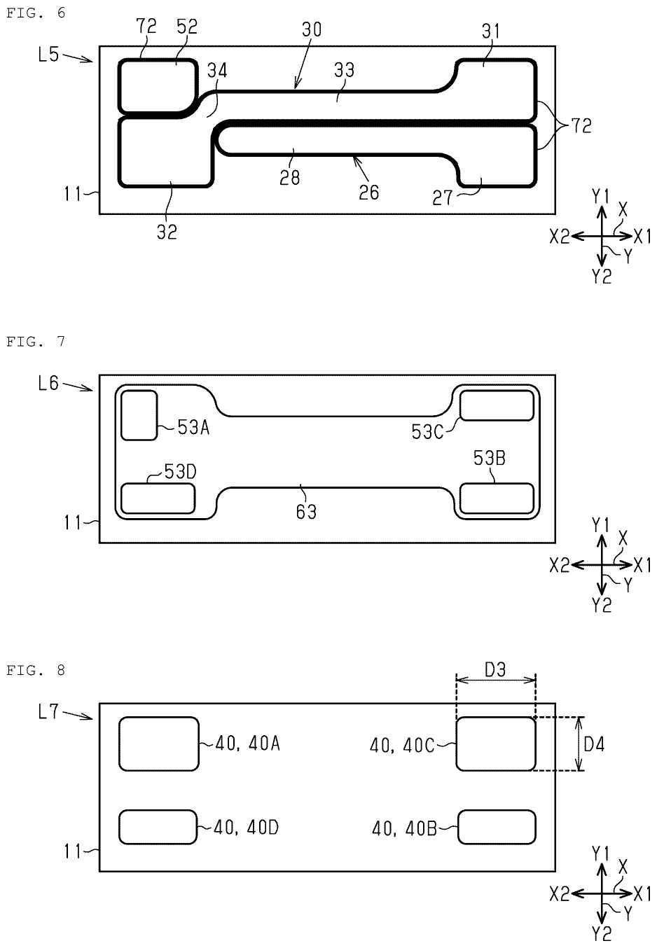

As illustrated in FIG. 2, the sixth layer L6 is laminated on the third positive direction Z1 side with respect to the fifth layer L5. As illustrated in FIG. 7, an outer shape of the sixth layer L6 is the same rectangular shape as the first layer L1. The sixth layer L6 includes a third interlayer insulating layer 63, a first via 53A, a second via 53B, a third via 53C, a fourth via 53D, and the element body 11. A portion of the sixth layer L6 excluding the third interlayer insulating layer 63, the first via 53A, the second via 53B, the third via 53C, and the fourth via 53D is the element body 11. The material of the second interlayer insulating layer 62 is the insulating resin. Materials of the first via 53A, the second via 53B, the third via 53C, and the fourth via 53D are all conductive metals, for example, copper.

An outer shape of the third interlayer insulating layer 63 is the same shape as the first interlayer insulating layer 61 and the second interlayer insulating layer 62. When viewed in the direction parallel to the third axis Z, an outer edge of the third interlayer insulating layer 63 substantially coincides with the outer edge of the first interlayer insulating layer 61 and the outer edge of the second interlayer insulating layer 62.

The first via 53A has a quadrangular shape in plan view. The first via 53A is located at a corner on the first negative direction X2 side and the second positive direction Y1 side in the sixth layer L6. Specifically, the first via 53A is located on the intermediate pad 52 in the fifth layer L5. Note that the first via 53A is located in a region surrounded by the outer edge of the third interlayer insulating layer 63.

The second via 53B has a quadrangular shape in plan view. The second via 53B is located at a corner on the first positive direction X1 side and the second negative direction Y2 side in the sixth layer L6. Specifically, the second via 53B is located on the pad 27 of the first auxiliary wiring 26 in the fifth layer L5. Note that the second via 53B is located in the region surrounded by the outer edge of the third interlayer insulating layer 63.

The third via 53C has a quadrangular shape in plan view. The third via 53C is located at a corner on the first positive direction X1 side and the second positive direction Y1 side in the sixth layer L6. Specifically, the third via 53C is located on the first pad 31 of the second inductor wiring 30 in the fifth layer L5. Note that the third via 53C is located in the region surrounded by the outer edge of the third interlayer insulating layer 63.

The fourth via 53D has a quadrangular shape in plan view. The fourth via 53D is located at a corner on the first negative direction X2 side and the second negative direction Y2 side in the sixth layer L6. Specifically, the fourth via 53D is located on the second pad 32 of the second inductor wiring 30 in the fifth layer L5. Note that the fourth via 53D is located in the region surrounded by the outer edge of the third interlayer insulating layer 63.

As illustrated in FIG. 2, the seventh layer L7 is laminated on the third positive direction Z1 side with respect to the sixth layer L6. A surface of the seventh layer L7 facing the third positive direction Z1 side is the first main surface 11A of the element body 11. As illustrated in FIG. 8, an outer shape of the seventh layer L7 is the same rectangular shape as the first layer L1. The seventh layer L7 includes a first vertical wiring 40A, a second vertical wiring 40B, a third vertical wiring 40C, and a fourth vertical wiring 40D as the vertical wirings 40. The seventh layer L7 has the element body 11. A portion of the seventh layer L7 excluding the first vertical wiring 40A, the second vertical wiring 40B, the third vertical wiring 40C, and the fourth vertical wiring 40D is the element body 11. Materials of the first vertical wiring 40A, the second vertical wiring 40B, the third vertical wiring 40C, and the fourth vertical wiring 40D are all conductive metals, for example, copper.

The first vertical wiring 40A has a quadrangular shape in plan view. The first vertical wiring 40A is located at a corner on the first negative direction X2 side and the second positive direction Y1 side in the seventh layer L7. Specifically, the first vertical wiring 40A is located on the first via 53A in the sixth layer L6. Therefore, the first vertical wiring 40A is connected to the first pad 21 of the first inductor wiring 20 via the first via 53A, the intermediate pad 52, and the via portion 51 in the direction orthogonal to the first main surface 11A.

The second vertical wiring 40B has a quadrangular shape in plan view. The second vertical wiring 40B is located at a corner on the first positive direction X1 side and the second negative direction Y2 side in the seventh layer L7. Specifically, the second vertical wiring 40B is located on the second via 53B in the sixth layer L6. Therefore, the second vertical wiring 40B is connected to the second pad 22 of the first inductor wiring 20 via the second via 53B, the pad 27 of the first auxiliary wiring 26, and the first via wiring 25 in the direction orthogonal to the first main surface 11A.

The third vertical wiring 40C has a quadrangular shape in plan view. The third vertical wiring 40C is located at a corner on the first positive direction X1 side and the second positive direction Y1 side in the seventh layer L7. Specifically, the third vertical wiring 40C is located on the third via 53C in the sixth layer L6. Therefore, the third vertical wiring 40C is connected to the first pad 31 of the second inductor wiring 30 via the third via 53C in the direction orthogonal to the first main surface 11A.

The fourth vertical wiring 40D has a quadrangular shape in plan view. The fourth vertical wiring 40D is located at a corner on the first negative direction X2 side and the second negative direction Y2 side in the seventh layer L7. Specifically, the fourth vertical wiring 40D is located on the fourth via 53D in the sixth layer L6. Therefore, the fourth vertical wiring 40D is connected to the second pad 32 of the second inductor wiring 30 via the fourth via 53D in the direction orthogonal to the first main surface 11A.

A maximum dimension D3 of each of the vertical wirings 40 in a direction parallel to the long side of the first main surface 11A is larger than a maximum dimension D4 of the same vertical wiring 40 in a direction parallel to the short side of the first main surface 11A. Note that in FIG. 8, only the third vertical wiring 40C is denoted by reference numerals of the maximum dimension D3 and the maximum dimension D4, but the other vertical wirings 40 also satisfy the same magnitude relationship.

As illustrated in FIG. 2, the eighth layer L8 is laminated on the third positive direction Z1 side with respect to the seventh layer L7. An outer shape of the eighth layer L8 is the same rectangular shape as the first layer L1. As illustrated in FIG. 1, the eighth layer L8 includes a first external terminal 50A, a second external terminal 50B, a third external terminal 50C, and a fourth external terminal 50D as the external terminals 50. The eighth layer L8 includes the protective film 55. The protective film 55 covers a region not covered by each of external terminals 50 on a surface of the seventh layer L7 facing the third positive direction Z1. A material of the protective film 55 is an insulating resin. Materials of the first external terminal 50A, the second external terminal 50B, the third external terminal 50C, and the fourth external terminal 50D are all conductive metals. Although not illustrated, each of external terminals 50 has a three-layer structure of a layer made of copper, a layer made of nickel, and a layer made of gold in order from the element body 11 side.

As illustrated in FIG. 1, the first external terminal 50A has a quadrangular shape in plan view. The first external terminal 50A is located at a corner on the first negative direction X2 side and the second positive direction Y1 side in the eighth layer L8. Specifically, the first external terminal 50A is located on the first vertical wiring 40A in the seventh layer L7. Therefore, the first external terminal 50A is connected to the first pad 21 of the first inductor wiring 20 via the first vertical wiring 40A in the direction orthogonal to the first main surface 11A.

The second external terminal 50B has a quadrangular shape in plan view. The second external terminal 50B is located at a corner on the first positive direction X1 side and the second negative direction Y2 side in the eighth layer L8. Specifically, the second external terminal 50B is located on the second vertical wiring 40B in the seventh layer L7. Therefore, the second external terminal 50B is connected to the second pad 22 of the first inductor wiring 20 via the second vertical wiring 40B in the direction orthogonal to the first main surface 11A.

The third external terminal 50C has a quadrangular shape in plan view. The third external terminal 50C is located at a corner on the first positive direction X1 side and the second positive direction Y1 side in the eighth layer L8. Specifically, the third external terminal 50C is located on the third vertical wiring 40C in the seventh layer L7. Therefore, the third external terminal 50C is connected to the first pad 31 of the second inductor wiring 30 via the third vertical wiring 40C in the direction orthogonal to the first main surface 11A.

The fourth external terminal 50D has a quadrangular shape in plan view. The fourth external terminal 50D is located at a corner on the first negative direction X2 side and the second negative direction Y2 side in the eighth layer L8. Specifically, the fourth external terminal 50D is located on the fourth vertical wiring 40D in the seventh layer L7. Therefore, the fourth external terminal 50D is connected to the second pad 32 of the second inductor wiring 30 via the fourth vertical wiring 40D in the direction orthogonal to the first main surface 11A.

### Method for Manufacturing Inductor Component

Next, a method for manufacturing the inductor component 10 will be described.

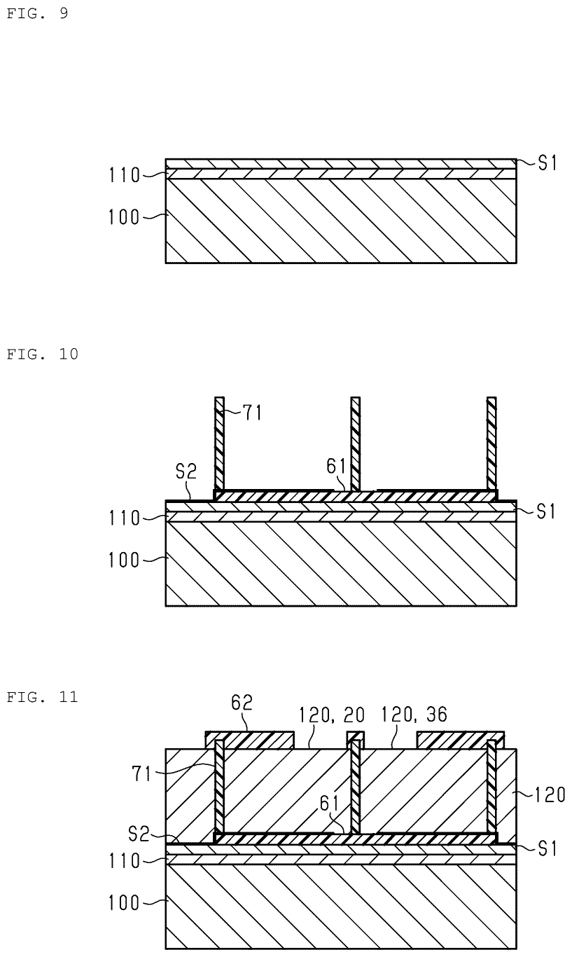

As illustrated in FIG. 9, first, a first seed layer S1 is laminated on a base substrate 100 with an adhesive layer 110 interposed therebetween. A material of the first seed layer S1 is a conductive metal. Next, as illustrated in FIG. 10, the first interlayer insulating layer 61 is formed on the first seed layer S1. The first interlayer insulating layer 61 is formed in a desired shape by, for example, a photolithography method. Thereafter, a second seed layer S2 is formed on the first seed layer S1 and the first interlayer insulating layer 61. A material of the second seed layer S2 is a conductive metal. The second seed layer S2 is formed in a desired shape by removing a specific region of a metal film formed by sputtering by etching. At this time, an interval of the second seed layer S2 is set to be larger than an interval between the first inductor wiring 20 and the second auxiliary wiring 36 to be formed, at a position corresponding between the first inductor wiring 20 and the second auxiliary wiring 36. Thereafter, the first in-layer insulating layer 71 is formed on the first interlayer insulating layer 61. The first in-layer insulating layer 71 is formed in a desired shape by, for example, the photolithography method.

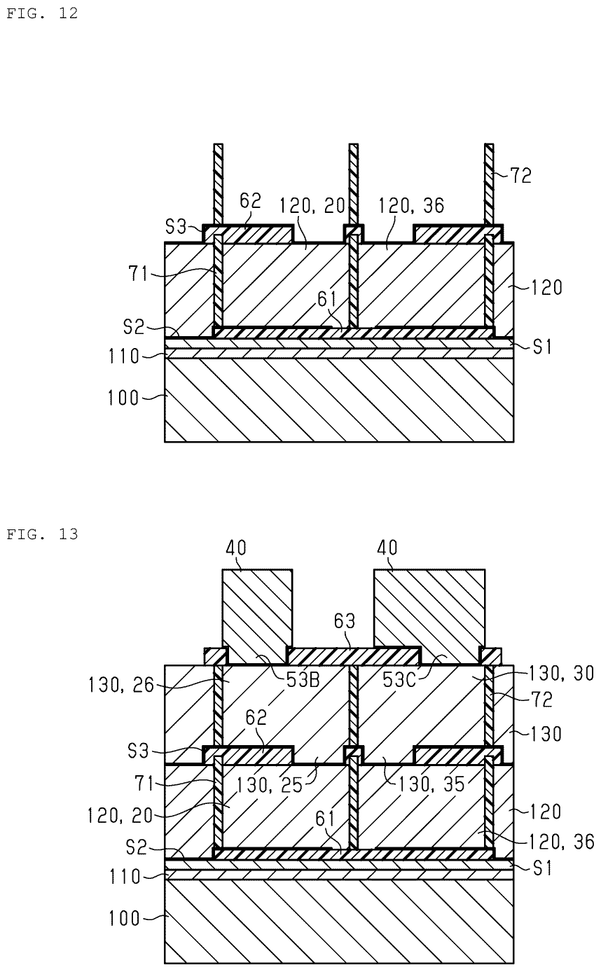

Next, as illustrated in FIG. 11, a metal layer 120 is formed on the second seed layer S2. The metal layer 120 is formed by electrolytic plating using the first seed layer S1 and the second seed layer S2 as power supply layers. In the metal layer 120, a portion between first in-layer insulating layers 71 corresponds to the first inductor wiring 20 or the second auxiliary wiring 36. Thereafter, the second interlayer insulating layer 62 is formed on the metal layer 120 and the first in-layer insulating layer 71. The second interlayer insulating layer 62 is formed in a desired shape by, for example, the photolithography method.

Next, as illustrated in FIG. 12, a third seed layer S3 is formed on the metal layer 120 and the second interlayer insulating layer 62. A material of the third seed layer S3 is a conductive metal. The third seed layer S3 is formed in a desired shape by removing a specific region of the metal film formed by sputtering by etching. Next, the second in-layer insulating layer 72 is formed on the third seed layer S3 laminated on the second interlayer insulating layer 62. The second in-layer insulating layer 72 is formed in a desired shape by, for example, the photolithography method.

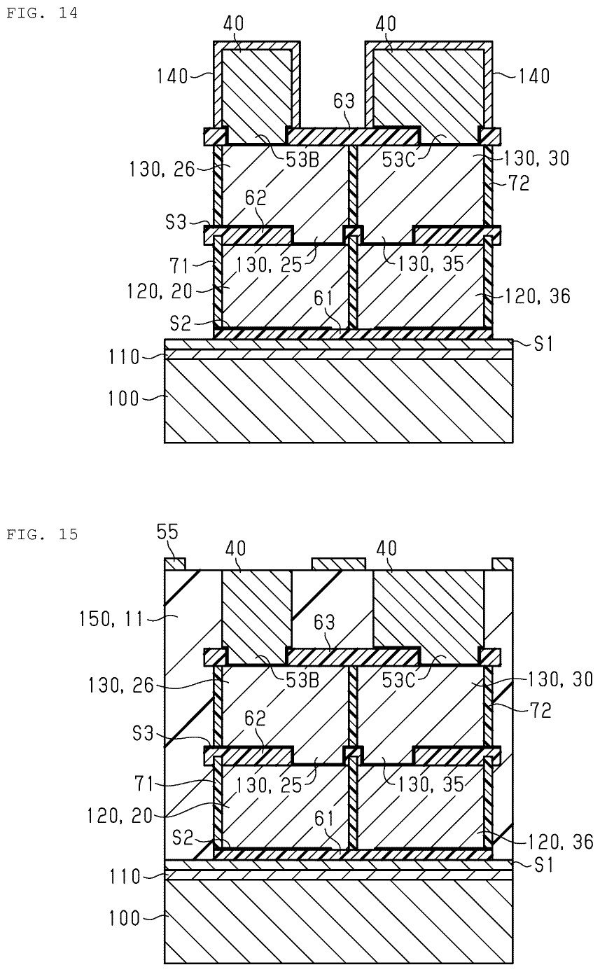

Next, as illustrated in FIG. 13, a metal layer 130 is formed on the third seed layer S3. The metal layer 130 is formed by electrolytic plating using the third seed layer S3 as the power supply layer. In the metal layer 130, a portion in the same layer as the second interlayer insulating layer 62 corresponds to the first via wiring 25 or the second via wiring 35. In the metal layer 130, a portion between second in-layer insulating layers 72 corresponds to the second inductor wiring 30 and the first auxiliary wiring 26. Thereafter, the third interlayer insulating layer 63 is formed on the metal layer 130 and the second in-layer insulating layer 72. The third interlayer insulating layer 63 is formed in a desired shape by, for example, the photolithography method. Furthermore, the first via 53A to the fourth via 53D and the vertical wirings 40 are formed on the metal layer 130 and the third interlayer insulating layer 63. Although not illustrated, the first via 53A to the fourth via 53D and the vertical wirings 40 are formed as follows. First, a seed layer is formed on an entire surface of the metal layer 130 and the third interlayer insulating layer 63. A resist layer having a desired shape is formed on the seed layer by the photolithography method. The resist layer at this time has a shape having a hole in a portion where the first via 53A to the fourth via 53D and the vertical wirings 40 are formed. Then, the first via 53A to fourth via 53D and the vertical wirings 40 are formed in a portion of the hole of the resist layer by electrolytic plating. Thereafter, the resist layer is peeled off, and then the seed layer on the metal layer 130 and the third interlayer insulating layer 63 is removed.

After the vertical wirings 40 are formed, as illustrated in FIG. 14, a resist 140 that covers an outer surface of each of the vertical wirings 40 is formed. The resist 140 is formed by, for example, the photolithography method. Then, a portion of the metal layer 120 not surrounded by the first in-layer insulating layer 71 and a portion of the metal layer 130 not surrounded by the second in-layer insulating layer 72 are removed by etching.

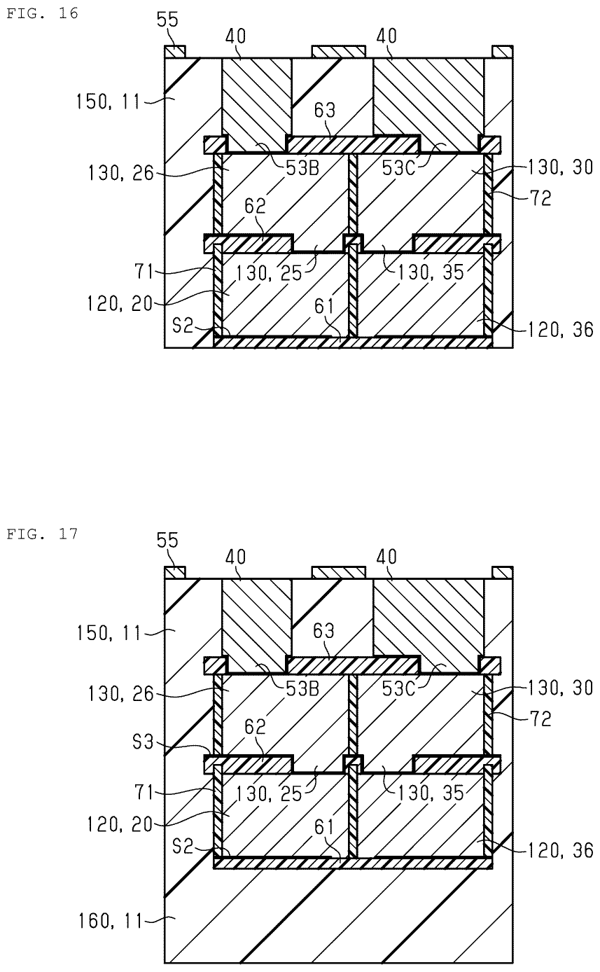

Next, as illustrated in FIG. 15, the resist 140 is peeled off and removed. Then, a magnetic material 150 is pressed against the base substrate 100 to dispose the magnetic material 150 around a structure described above on the base substrate 100. At this time, the end surface of each of the vertical wirings 40 is exposed from the magnetic material 150. Then, the magnetic material 150 is cured to form a part of the element body 11. In addition, the protective film 55 is formed on a surface of the element body 11 opposite to the base substrate 100. The protective film 55 is formed in a desired shape by, for example, the photolithography method.

Next, as illustrated in FIG. 16, the base substrate 100, the adhesive layer 110, and the first seed layer S1 are removed from the structure on the base substrate 100. For example, the base substrate 100 and the adhesive layer 110 are removed by mechanical peeling. The first seed layer S1 is removed by, for example, wet etching.

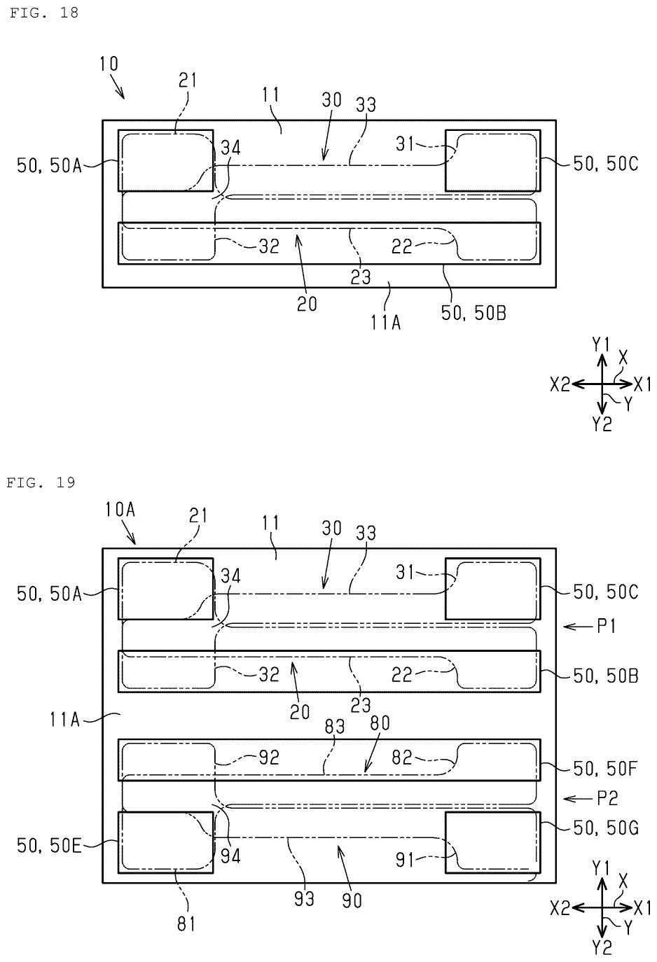

Next, as illustrated in FIG. 17, the magnetic material 160 is pressed against the structure from a side where the base substrate 100 is disposed, to dispose the magnetic material 160. Then, the magnetic material 160 is cured to form a part of the element body 11. Specifically, the magnetic material 160 becomes the element body 11 of the first layer L1. Thereafter, as illustrated in FIG. 2, the external terminal 50 is formed on the same layer as the protective film 55. The external terminal 50 is formed as a terminal including a plurality of layers by sputtering, electrolytic plating, or the like.

Note that in FIGS. 9 to 17, it has been described that one inductor component 10 is formed, but a plurality of the inductor components 10 are formed in parallel on one base substrate 100. Therefore, the plurality of inductor components 10 are manufactured by cutting the inductor component manufactured by the method illustrated in FIGS. 9 to 17 into individual pieces.

### Effects of Embodiment

According to the above embodiment, the following effects are obtained.
(1) In the above embodiment, it is assumed that a current is caused to flow through the first straight wiring 23 of the first inductor wiring 20 in the first positive direction X1, and a current is caused to flow through the second straight wiring 33 of the second inductor wiring 30 in the first negative direction X2. At this time, the first pad 21 of the first inductor wiring 20 and the first pad 31 of the second inductor wiring 30 are on the high potential side, and the second pad 22 of the first inductor wiring 20 and the second pad 32 of the second inductor wiring 30 are on the low potential side.

In the above embodiment, the second inductor wiring 30 and the first inductor wiring 20 intersect each other. As a result, both the first pad 21 of the first inductor wiring 20 and the first pad 31 of the second inductor wiring 30 are close to the second positive direction Y1 side in the inductor component 10. Then, the second pad 22 of the first inductor wiring 20 and the second pad 32 of the second inductor wiring 30 are both close to the second negative direction Y2 side in the inductor component 10. That is, when currents flow in opposite directions through the first inductor wiring 20 and the second inductor wiring 30, an end of the first inductor wiring 20 to which a high potential is applied and an end of the second inductor wiring 30 to which a high potential is applied are arranged on the second positive direction Y1 side of the inductor component 10. With such a structure, for example, on the substrate, wirings for supplying a high potential to the inductor component 10 can be concentrated on one side with respect to a mounting position of the inductor component 10. Therefore, it is possible to prevent a wiring routing structure on the substrate from being complicated.
(2) In the above embodiment, the second interlayer insulating layer 62 is present between the third layer L3 in which the first inductor wiring 20 is present and the fifth layer L5 in which the second inductor wiring 30 is present in the direction orthogonal to the first main surface 11A. Due to the presence of the second interlayer insulating layer 62, for example, even when the manufacturing error occurs in the first inductor wiring 20 and the second inductor wiring 30, it is possible to reduce a possibility that both inductor wirings are short-circuited.
(3) In the above embodiment, the inductor component 10 includes the first via wiring 25 and the first auxiliary wiring 26. Then, the first inductor wiring 20 is connected to the first auxiliary wiring 26 via the first via wiring 25. In a portion where the first inductor wiring 20, the first via wiring 25, and the first auxiliary wiring 26 run in parallel, all of them function as one wiring. Therefore, an AC resistance can be reduced as compared with the case of the first inductor wiring 20 alone.
(4) In the above embodiment, the first main surface 11A of the element body 11 has a rectangular shape that is long in the direction parallel to the first axis X. Then, the maximum dimension D3 of each of the vertical wirings 40 in the direction parallel to the long side of first main surface 11A is larger than the maximum dimension D4 of the same vertical wiring 40 in the direction parallel to the short side of the first main surface 11A. By matching a direction in which the vertical wirings 40 are elongated with a direction of the long side of the first main surface 11A in this way, it is possible to ensure a sufficient interval as an interval between the vertical wirings 40 while increasing an area of the vertical wirings 40 in plan view.
(5) The maximum dimension H2 of the second straight wiring 33 in the direction parallel to the third axis Z orthogonal to the first main surface 11A is in a range of 80% or more and 120% or less (i.e., from 80% to 120%) of the maximum dimension H1 of the first straight wiring 23 in the same direction. That is, a height dimension of the first straight wiring 23 and a height dimension of the second straight wiring 33 do not greatly deviate from each other. With such a configuration, it is possible to prevent performance of the first inductor wiring 20 and the second inductor wiring 30 from deviating from each other from the viewpoint of the AC resistance and inductance characteristics.
(6) In the above embodiment, although there is a portion that does not extend linearly when viewed as the entire first inductor wiring 20, the proportion of the first straight wiring 23 in the first inductor wiring 20 is 50% or more of the length of the first inductor wiring 20. With such a configuration, a portion extending in parallel with the second inductor wiring 30 can be secured to be considerably long, so that it is possible to suppress a decrease in coupling constant between both the inductor wirings.
(7) In the above embodiment, the shortest distance D1 from the first straight wiring 23 to the side surface 11C of the element body 11 is larger than the maximum width dimension D2 of the first straight wiring 23. In other words, a wide magnetic path is secured on the side surface side of the first straight wiring 23. Therefore, it is possible to suppress saturation in the element body 11 of magnetic flux generated when the current is caused to flow through the first inductor wiring 20.

### Modification

The above embodiment can be modified and implemented as follows. The above embodiment and the following modification can be implemented in combination with each other to the extent that no technical contradiction occurs.
The shape of the element body 11 is not necessarily a rectangular parallelepiped shape. The element body 11 only needs to have at least one planar main surface.

The shapes of the first pad 21 and the second pad 22 of the first inductor wiring 20 may be polygonal shapes other than quadrangular shapes, circular shapes, or elliptical shapes. In addition, the first pad 21 and the second pad 22 of the first inductor wiring 20 may be equal in width to the first straight wiring 23. The same applies to the second inductor wiring 30.

Sectional shapes of the first inductor wiring 20 and the second inductor wiring 30 of the above embodiment are examples and can be changed as appropriate. For example, as a dimensional requirement for the inductor component 10, while there may be a strong limitation on dimension in the direction orthogonal to the third axis Z, there may be no significant limitation on dimension in the direction parallel to the third axis Z. In this case, the maximum dimension H1 of the first straight wiring 23 in the direction parallel to the third axis Z is preferably larger than the maximum width dimension D2 of the first straight wiring 23. According to this dimensional relationship, an area of the first main surface 11A of the element body 11 can be reduced while maintaining a sectional area of the first straight wiring 23.

A relationship between the maximum dimension H1 of the first straight wiring 23 and the maximum dimension H2 of the second straight wiring 33 is not limited to an example of the above embodiment. That is, the maximum dimension H2 of the second straight wiring 33 may be less than 80% or more than 120% of the maximum dimension H1 of the first straight wiring 23. However, it is preferable that the sectional area of the first straight wiring 23 and a sectional area of the second straight wiring 33 do not largely deviate from each other.

The proportion of the first straight wiring 23 in the first inductor wiring 20 may be less than 50% of the length of the first inductor wiring 20. A length of the first straight wiring 23 is not limited as long as the first inductor wiring 20 has the first straight wiring 23 extending in parallel with the second straight wiring 33 of the second inductor wiring 30. The same applies to the second inductor wiring 30.

The shortest distance D1 from the first straight wiring 23 to the side surface 11C of the element body 11 may be equal to or less than the maximum width dimension D2 of the first straight wiring 23. The shortest distance D1 may be adjusted according to the material of the element body 11, strength of the magnetic flux generated when the current is caused to flow through the inductor component 10, or the like.

One or more layers selected from the first interlayer insulating layer 61, the second interlayer insulating layer 62, and the third interlayer insulating layer 63 may be omitted. Note that when these interlayer insulating layers are omitted, it is necessary to interpose the element body 11 between the wirings so that the wirings are not short-circuited in the direction parallel to the third axis Z.

One or more selected from the first in-layer insulating layer 71 and the second in-layer insulating layer 72 may be omitted. If a sufficient interval is secured between adjacent wirings in each layer, a short circuit between the wirings can be prevented even if the in-layer insulating layer is omitted.

When viewed in the direction orthogonal to the first main surface 11A, at least a part of the first auxiliary wiring 26 only needs to overlap the first straight wiring 23 of the first inductor wiring 20. In other words, a part of the first auxiliary wiring 26 may deviate from the first inductor wiring 20. The same applies to the second auxiliary wiring 36.

The first auxiliary wiring 26 may be omitted. When the first auxiliary wiring 26 is omitted, the first via wiring 25 is also omitted. The same applies to the second auxiliary wiring 36.

The magnitude relationship between the maximum dimension D3 in the direction parallel to the long side of first main surface 11A and the maximum dimension D4 in the direction parallel to the short side of the first main surface 11A in each of the vertical wirings 40 is not limited to the example of the above embodiment. That is, the maximum dimension D3 may be equal to or smaller than the maximum dimension D4.

A magnitude relationship between the maximum width dimension of the first via wiring 25 and the maximum width dimension D2 of the first straight wiring 23, in the direction parallel to the first main surface 11A is not limited to the example of the above embodiment. That is, the maximum width dimension of the first via wiring 25 in the direction parallel to the first main surface 11A may be the same as the maximum width dimension D2 of the first straight wiring 23, or may be larger than the maximum width dimension D2 of the first straight wiring 23. The same applies to the magnitude relationship between the maximum width dimension of the second via wiring 35 and the maximum width dimension of the second wiring portion 38, the magnitude relationship between the maximum width dimension of the second straight wiring 33 and the maximum width dimension of the second via wiring 35, and the magnitude relationship between the maximum width dimension of the first wiring portion 28 and the maximum width dimension of the first via wiring 25.

The shape of each of the vertical wirings 40 is not limited to a quadrangular shape when viewed in the direction orthogonal to the first main surface 11A. The shape of each of the vertical wirings 40 may be a polygonal shape other than a quadrangular shape, a circular shape, or an elliptical shape. Similarly, the shape of each of the external terminals 50 is not limited to a quadrangular shape when viewed in the direction orthogonal to the first main surface 11A.

The external terminal 50 connected to the second vertical wiring 40B and the external terminal 50 connected to the fourth vertical wiring 40D may be made common. For example, in an example illustrated in FIG. 18, the first external terminal 50A is positioned at the corner on the first negative direction X2 side and the second positive direction Y1 side as in the above embodiment. The third external terminal 50C is located at the corner on the first positive direction X1 side and the second positive direction Y1 side as in the above embodiment. On the other hand, the second external terminal 50B is located on the second negative direction Y2 side from the first external terminal 50A and the third external terminal 50C. The second external terminal 50B has a rectangular shape elongated in the direction parallel to the first axis X. When viewed in the direction parallel to the third axis Z, an end of the second external terminal 50B on the first positive direction X1 side overlaps the second pad 22 of the first inductor wiring 20. When viewed in the direction parallel to the third axis Z, an end of the second external terminal 50B on the first negative direction X2 side overlaps the second pad 32 of the second inductor wiring 30. That is, the second external terminal 50B is connected to both the second end of the first inductor wiring 20 and the second end of the second inductor wiring 30. Then, the second external terminal 50B also functions as the fourth external terminal 50D in the inductor component 10 of the first embodiment. According to this configuration, a difference between the potential of the second end of the first inductor wiring 20 and the potential of the second end of the second inductor wiring 30 is unlikely to occur. Therefore, electrical characteristics of the first inductor wiring 20 and electrical characteristics of the second inductor wiring 30 are unlikely to deviate from each other.

In the example illustrated in FIG. 18, the second vertical wiring 40B may be further connected to the fourth via 53D. In this case, the second vertical wiring 40B also functions as the fourth vertical wiring 40D. In addition, in this modification, the second via 53B may be connected to the second pad 32 of the second inductor wiring 30. In this case, the second via 53B also functions as the fourth via 53D. As described above, when the plurality of external terminals 50 are made common, the vertical wirings 40 corresponding to the external terminals 50 and the vias connected to the vertical wirings 40 can be made common together.

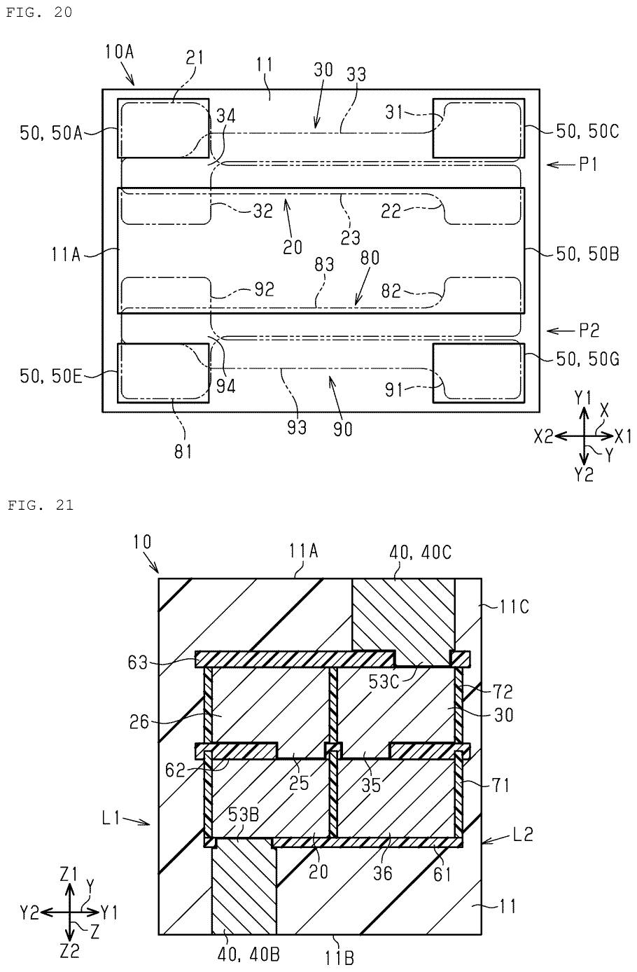

When the first inductor wiring 20 and the second inductor wiring 30 are formed as one set of inductor wirings, two or more sets of inductor wirings may be present in one element body 11. For example, an inductor component 10A illustrated in FIG. 19 has a first portion P1 that is a half on the second positive direction Y1 side and a second portion P2 that is a half on the second negative direction Y2 side. A structure of the first portion P1 is the same as a structure of the inductor component 10 of the first embodiment. A structure of the second portion P2 is mirror-symmetrical with respect to the first portion P1 in the direction along the second axis Y.

Here, one of two inductor wirings included in the second portion P2 is referred to as a third inductor wiring 80, and the other one is referred to as a fourth inductor wiring 90. The third inductor wiring 80 is mirror-symmetrical with respect to the first inductor wiring 20 in the direction along the second axis Y. Therefore, the third inductor wiring 80 is located in the same layer as the first inductor wiring 20 in the direction orthogonal to the first main surface 11A. The third inductor wiring 80 includes a first pad 81, a second pad 82, and a third straight wiring 83. The fourth inductor wiring 90 is mirror-symmetrical with respect to the second inductor wiring 30 in the direction along the second axis Y. Therefore, the fourth inductor wiring 90 is located in the same layer as the second inductor wiring 30 in the direction orthogonal to the first main surface 11A. The fourth inductor wiring 90 includes a first pad 91, a second pad 92, a fourth straight wiring 93, and an intersection portion 94.

When viewed in the direction parallel to the third axis Z, the second straight wiring 33, the first straight wiring 23, the third straight wiring 83, and the fourth straight wiring 93 are arranged in this order from the second positive direction Y1 side toward the second negative direction Y2 side. Then, the fourth inductor wiring 90 intersects the third inductor wiring 80 at the intersection portion 94. As a result, the first pad 81, which is a first end of the third inductor wiring 80, is located on an opposite side to the second pad 82, which is a second end of the third inductor wiring 80, with the fourth straight wiring 93 interposed therebetween. The first pad 91, which is a first end of the fourth inductor wiring 90, is located on an opposite side to the second pad 92, which is a second end of the fourth inductor wiring 90, with the third straight wiring 83 interposed therebetween.

When two or more sets of inductor wirings are present in one element body 11, one external terminal 50 may be connected to the plurality of inductor wirings. In an example illustrated in FIG. 19, arrangement and connection relationship of the external terminals 50 of the first portion P1 are the same as those in the example illustrated in FIG. 18. That is, the first external terminal 50A is connected to the first pad 21 of the first inductor wiring 20. The third external terminal 50C is connected to the first pad 31 of the second inductor wiring 30. The second external terminal 50B is connected to both the second pad 22 of the first inductor wiring 20 and the second pad 32 of the second inductor wiring 30.

In the example illustrated in FIG. 19, arrangement and connection relationship of the external terminals 50 of the second portion P2 are mirror-symmetrical with the example illustrated in FIG. 18 in the direction along the second axis Y. That is, a fifth external terminal 50E is connected to the first pad 81 of the third inductor wiring 80. A seventh external terminal 50G is connected to the first pad 91 of the fourth inductor wiring 90. A sixth external terminal 50F is connected to both the second pad 82 of the third inductor wiring 80 and the second pad 92 of the fourth inductor wiring 90.

Furthermore, in an example illustrated in FIG. 20, the second external terminal 50B is connected to all of the second pad 22 of the first inductor wiring 20, the second pad 32 of the second inductor wiring 30, the second pad 82 of the third inductor wiring 80, and the second pad 92 of the fourth inductor wiring 90. That is, in the example illustrated in FIG. 20, the second external terminal 50B also functions as the sixth external terminal 50F in the example illustrated in FIG. 19. In this way, when the second external terminal 50B is connected to the plurality of pads, potentials of the pads connected by the second external terminal 50B are substantially equal. Therefore, it is possible to suppress potential deviation of ends of four inductor wirings which are connected to the low potential.

The vertical wirings 40 exposed on the second main surface 11B side may be present. In an example illustrated in FIG. 21, the first layer L1 includes the second vertical wiring 40B. The second vertical wiring 40B penetrates the first layer L1. Therefore, the end surface of the second vertical wiring 40B on the third negative direction Z2 side is exposed on the second main surface 11B. The second layer L2 includes the second via 53B. The second via 53B penetrates the first interlayer insulating layer 61 in the second layer L2. Therefore, the second via 53B connects the second vertical wiring 40B and the first inductor wiring 20 in the direction parallel to the third axis Z. According to such a modification, position of a wiring for connecting to each inductor wiring is not limited to the first main surface 11A side of the element body 11. Therefore, for example, even when the substrate is disposed on both the first main surface 11A side and the second main surface 11B side of the inductor component 10 or the inductor component 10 is embedded in a semiconductor device, complication of wiring can be prevented.

Either or both of the external terminal 50 and the protective film 55 in the inductor component 10 can be omitted. In the example illustrated in FIG. 21, the inductor component 10 does not include the external terminal 50 and the protective film 55. In this case, end surfaces of the vertical wirings 40 are exposed on the outer surfaces of the element body 11. Then, the end surfaces of the vertical wirings 40 also function as the external terminals 50.

The inductor component 10 of the above embodiment may constitute the semiconductor device together with a processor, a package board, a power management IC (PMIC), a motherboard, or the like. In such a semiconductor device, since the package board or the like can exist on both the third positive direction Z1 side and the third negative direction Z2 side of the inductor component 10, the inductor component 10 as the modification illustrated in FIG. 21 is suitable.

The manufacturing method of the above embodiment is an example. It is sufficient that structure of each layer in the inductor component 10 can be formed by combining known film formation methods, patterning methods, and plating methods. A suitable step may be selected according to the material of the member constituting each layer, or the like.

What is claimed is:

1. An inductor component comprising:
an element body having a planar main surface;
a first inductor wiring extending parallel to the main surface in the element body;
a second inductor wiring in a layer different from the first inductor wiring in a direction orthogonal to the main surface and extending parallel to the main surface in the element body; and
a plurality of vertical wirings electrically connected to a wiring inside the element body, and extending in a direction intersecting the main surface to be exposed on an outer surface of the element body, wherein
the first inductor wiring includes a first straight wiring extending linearly,
the second inductor wiring includes a second straight wiring extending parallel to the first straight wiring,
the second inductor wiring intersects the first inductor wiring when viewed in a direction orthogonal to the main surface,
a first end of the first inductor wiring is on a side opposite to a second end of the first inductor wiring across the second straight wiring, and
a first end of the second inductor wiring is on a side opposite to a second end of the second inductor wiring across the first straight wiring.

2. The inductor component according to claim 1, further comprising:
an insulating layer between the first inductor wiring and the second inductor wiring in a direction orthogonal to the main surface, and the insulating layer including a material having a larger electric resistance value than the element body.

3. The inductor component according to claim 1, further comprising:
a first auxiliary wiring in the same layer as the second inductor wiring in a direction orthogonal to the main surface; and
a first via wiring between the first inductor wiring and the first auxiliary wiring in a direction orthogonal to the main surface and connecting the first straight wiring and the first auxiliary wiring, wherein
the first auxiliary wiring and the first via wiring extend parallel to the first straight wiring so as to overlap the first straight wiring when viewed in a direction orthogonal to the main surface.

4. The inductor component according to claim 1, wherein
the main surface has a rectangular shape having a short side and a long side longer than the short side,
the first straight wiring and the second straight wiring extend parallel to the long side, and
a maximum dimension of the vertical wiring in a direction parallel to the long side is larger than a maximum dimension of the vertical wiring in a direction parallel to the short side.

5. The inductor component according to claim 1, wherein
when viewed in a section orthogonal to an axis along which the second straight wiring extends, a maximum dimension of the second straight wiring in a direction orthogonal to the main surface is in a range of from 80% to 120% with respect to a maximum dimension of the first straight wiring in a direction orthogonal to the main surface.

6. The inductor component according to claim 1, wherein
a proportion occupied by the first straight wiring in the first inductor wiring is 50% or more of a length of the first inductor wiring.

7. The inductor component according to claim 1, wherein
a shortest distance from the first straight wiring to the outer surface of the element body in a direction parallel to the main surface and orthogonal to an extending direction of the first straight wiring is larger than a maximum width dimension of the first straight wiring in a direction parallel to the main surface.

8. The inductor component according to claim 1, further comprising:
a plurality of external terminals covering a part of the outer surface of the element body and connected to any one selected from the first end of the first inductor wiring, the second end of the first inductor wiring, the first end of the second inductor wiring, and the second end of the second inductor wiring in a direction orthogonal to the main surface via any one of the vertical wirings, wherein
one of the plurality of external terminals is connected to both the second end of the first inductor wiring and the second end of the second inductor wiring.

9. The inductor component according to claim 1, wherein
a maximum dimension of the first straight wiring in a direction orthogonal to the main surface is larger than a maximum width dimension of the first straight wiring in a direction parallel to the main surface when viewed in a section orthogonal to an axis along which the first straight wiring extends.

10. The inductor component according to claim 1, wherein
when the main surface is a first main surface,
the element body has a second main surface parallel to the first main surface on a side opposite to the first main surface, and
one or more of the vertical wirings are exposed on the first main surface, and another one or more of the vertical wirings are exposed on the second main surface.

11. The inductor component according to claim 1, further comprising:
a third inductor wiring in the same layer as the first inductor wiring in a direction orthogonal to the main surface and extending parallel to the main surface in the element body; and
a fourth inductor wiring in the same layer as the second inductor wiring in a direction orthogonal to the main surface and extending parallel to the main surface in the element body, wherein
the third inductor wiring includes a third straight wiring extending linearly,
the fourth inductor wiring includes a fourth straight wiring extending parallel to the third straight wiring,
the fourth inductor wiring intersects the third inductor wiring when viewed in a direction orthogonal to the main surface,
a first end of the third inductor wiring is on a side opposite to a second end of the third inductor wiring across the fourth straight wiring, and
a first end of the fourth inductor wiring is on a side opposite to a second end of the fourth inductor wiring across the third straight wiring.

12. The inductor component according to claim 11, further comprising:
a plurality of external terminals covering a part of the outer surface of the element body and connected to any one selected from the first end of the first inductor wiring, the second end of the first inductor wiring, the first end of the second inductor wiring, the second end of the second inductor wiring, the first end of the third inductor wiring, the second end of the third inductor wiring, the first end of the fourth inductor wiring, and the second end of the fourth inductor wiring in a direction orthogonal to the main surface via any one of the vertical wirings, wherein
one of the plurality of external terminals is connected to all of the second end of the first inductor wiring, the second end of the second inductor wiring, the second end of the third inductor wiring, and the second end of the fourth inductor wiring.

13. The inductor component according to claim 2, further comprising:
a first auxiliary wiring in the same layer as the second inductor wiring in a direction orthogonal to the main surface; and
a first via wiring between the first inductor wiring and the first auxiliary wiring in a direction orthogonal to the main surface and connecting the first straight wiring and the first auxiliary wiring, wherein
the first auxiliary wiring and the first via wiring extend parallel to the first straight wiring so as to overlap the first straight wiring when viewed in a direction orthogonal to the main surface.

14. The inductor component according to claim 2, wherein
the main surface has a rectangular shape having a short side and a long side longer than the short side,
the first straight wiring and the second straight wiring extend parallel to the long side, and
a maximum dimension of the vertical wiring in a direction parallel to the long side is larger than a maximum dimension of the vertical wiring in a direction parallel to the short side.

15. The inductor component according to claim 2, wherein
when viewed in a section orthogonal to an axis along which the second straight wiring extends, a maximum dimension of the second straight wiring in a direction orthogonal to the main surface is in a range of from 80% to 120% with respect to a maximum dimension of the first straight wiring in a direction orthogonal to the main surface.

16. The inductor component according to claim 2, wherein
a proportion occupied by the first straight wiring in the first inductor wiring is 50% or more of a length of the first inductor wiring.

17. The inductor component according to claim 2, wherein
a shortest distance from the first straight wiring to the outer surface of the element body in a direction parallel to the main surface and orthogonal to an extending direction of the first straight wiring is larger than a maximum width dimension of the first straight wiring in a direction parallel to the main surface.

18. The inductor component according to claim 2, further comprising:
a plurality of external terminals covering a part of the outer surface of the element body and connected to any one selected from the first end of the first inductor wiring, the second end of the first inductor wiring, the first end of the second inductor wiring, and the second end of the second inductor wiring in a direction orthogonal to the main surface via any one of the vertical wirings, wherein
one of the plurality of external terminals is connected to both the second end of the first inductor wiring and the second end of the second inductor wiring.

19. The inductor component according to claim 2, wherein
a maximum dimension of the first straight wiring in a direction orthogonal to the main surface is larger than a maximum width dimension of the first straight wiring in a direction parallel to the main surface when viewed in a section orthogonal to an axis along which the first straight wiring extends.

20. The inductor component according to claim 2, wherein
when the main surface is a first main surface,
the element body has a second main surface parallel to the first main surface on a side opposite to the first main surface, and
one or more of the vertical wirings are exposed on the first main surface, and another one or more of the vertical wirings are exposed on the second main surface.
